(19) United States
(12) Patent Application Publication
(10) Pub. No.: US 2023/0410113 A1
(43) Pub. Date: Dec. 21, 2023

(54) DETECTING NETWORK PATTERNS USING RANDOM WALKS

(71) Applicant: International Business Machines Corporation, Armonk, NY (US)

(72) Inventors: Krzysztof P Onak, Holliston, MA (US); Shashanka Ubaru, Ossining, NY (US); Amir Abboud, Sunnyvale, CA (US); Toyotaro Suzumura, Tokyo (JP)

(21) Appl. No.: 17/664,249

(22) Filed: May 20, 2022

(51) Int. Cl. G06Q 20/40

(52) U.S. Cl. CPC G06Q 20/4016

(57) ABSTRACT

A system may receive a dynamic network graph and select an origination node. From the origination node, the system may deploy a random walk simulation on the dynamic network graph simulating steps from the origination node to one or more other nodes, and determine a convergence node for the random walk simulation.

### BACKGROUND

Aspects of the present disclosure relate to detecting network patterns using random walks.

A financial network is a concept describing any collection of financial entities (such as traders, firms, banks and financial exchanges) and the links between them, ideally through direct transfers or the ability to mediate a transfer.

Data networks refer to systems designed to transfer data between two or more access points via the use of system controls, transmission lines and data switching.

### BRIEF SUMMARY

The present disclosure provides a method, computer program product, and system of detecting network patterns using random walks. In some embodiments, the method includes receiving a dynamic network graph, selecting an origination node, deploying a random walk simulation on the dynamic network graph simulating steps from the origination node to one or more other nodes, and determining, from the results of the random walk simulations, a convergence node for the random walk simulation.

Some embodiments of the present disclosure can also be illustrated by a computer program product comprising a computer readable storage medium having program instructions embodied therewith, the program instructions executable by a processor to cause the processors to perform a method, the method comprising receiving a dynamic network graph, selecting an origination node, deploying a random walk simulation on the dynamic network graph simulating steps from the origination node to one or more other nodes, and determining, from the results of the random walk simulations, a convergence node for the random walk simulation.

Some embodiments of the present disclosure can also be illustrated by a system comprising a processor and a memory in communication with the processor, the memory containing program instructions that, when executed by the processor, are configured to cause the processor to perform a method, the method comprising receiving a dynamic network graph, selecting an origination node, deploying a random walk simulation on the dynamic network graph simulating steps from the origination node to one or more other nodes, and determining, from the results of the random walk simulations, a convergence node for the random walk simulation.

### BRIEF DESCRIPTION OF THE DRAWINGS

FIG. 1A depicts an example network where a random walk simulation is being deployed, according to various embodiments of the present invention.

FIG. 1B depicts an example network where a random walk simulation is being deployed, according to various embodiments of the present invention.

FIG. 2 illustrates an example flow graph for performing random walk simulations in parallel.

FIG. 3 illustrates an example method of detecting network patterns using random walks, according to various embodiments of the present invention.

FIG. 4 depicts a computer system according to various embodiments of the present invention.

FIG. 5 depicts a cloud computing environment according to various embodiments of the present invention.

FIG. 6 depicts abstraction model layers according to various embodiments of the present invention.

### DETAILED DESCRIPTION

Aspects of the present disclosure relate to detecting network patterns using random walks. While the present disclosure is not necessarily limited to such applications, various aspects of the disclosure may be appreciated through a discussion of various examples using this context.

Since financial system and data systems are becoming increasingly complex and are strongly interrelated, the interconnectedness among institutions can lead to a rapid propagation of transactions. In this regard, interconnectedness represents a key aspect of financial stability and data access. However, millions of interactions between nodes make tracking illicit activities (few in number) amongst an astounding amount transactions impossible to detect using traditional means. Many instances of money laundering or data hijacking (amongst other illicit activities in networks) are done with many small transfers instead of a few large transfers. For example, large transfers of money or data are often flagged for review, but it is impossible to track the multitude of small transfers that are commonplace on networks. For example, money laundering may transfer large amounts of money (e.g., $1,000,000) from a first node (e.g., a bank account, credit account, crypto currency account, etc.) to a second node with a large number of small transfers ($100-1000) by way of a number of intermediary accounts. Since the transfers are proceeding through a number of intermediary accounts, it may be difficult to determine that the bulk of the money is going from the first account to the second account. Similar transfers may happen in other types of networks, such as data networks.

Therefore, in some embodiments, a method of determining links on nodes with random walks is proposed.

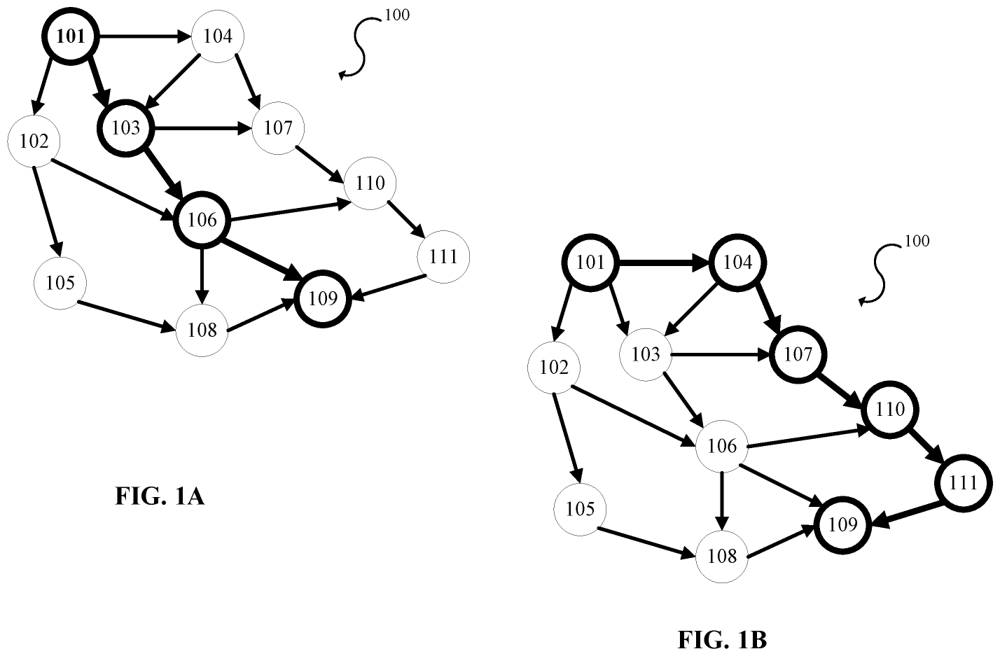

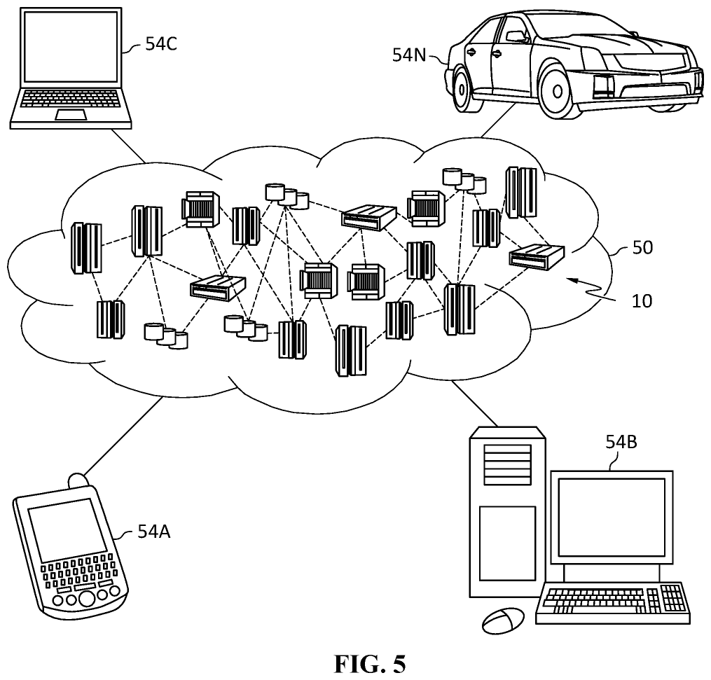

FIG. 1A and 1B depict an example deployment of a random walk simulation (RWS) in a network 100. In some embodiments, network 100 may be a financial network, a data network, or another kind of network where transfers or transfer take place. In some embodiments, the network may be deployed, in full or in part, on a cloud network, such as cloud computing network 50 depicted in FIG. 5. In some embodiments, nodes 101, 102, 103, 104, 105, 106, 107, 108, 109, 110, and 111 may be accounts, institutions, computers, servers, etc. Network 100 has arrows depicting example transfers, but other transfers (not shown for simplicity purposes) may be envisioned. For example, the transfers may happen in both directions, other nodes may be present with transfers to and from the depicted nodes, and there may be other transfers between the depicted nodes. In some instances, each arrow may represent a number of transfers. For example, there may be 100 transfers between node 101 and 102 and 10,000 transfers between node 101 and 104.

In some embodiments, an origination node may be selected for the RWS. The origination node may be selected based on the outgoing transfers from each node. For example, origination nodes may be selected based on a large (e.g., 1000 transfers a day) number of small size (e.g., less than $10,000 or 100 megabits) outgoing transfers for a certain time period (e.g., a day or week).

In some embodiments, the number of transfers between each node may affect the likelihood that the random walk takes a step between nodes. Following the example from above, if there may be 100 transfers between node 101 and 102 and 10,000 transfers between node 101 and 104, the step from node 101 and node 104 may be 100 times more likely than a step from 101 and 102 because there are 100 times more transfers from node 101 to 104 than 101 and 102.

In some embodiments, the random walk simulation randomly (based on the number of transfers from one node to another) steps between nodes. In some embodiments, the random walk simulation creates multiple instances of possible transfer paths between nodes. FIG. 1A and 1B each depict a single instance, but the simulation may create multiple instances (e.g., hundreds or thousands). The results of the multiple instances may be aggregated to determine a convergence node as described herein. In some embodiments, the number of steps may be set for the simulation. For example, a RWS may be set to take a maximum of 10 steps from one node to another. FIG. 1A depicts a first instance of a RWS starting at origination node 101 to 103, then to 106, and then to 109. FIG. 1B depicts a second instance of the RWS starting at origination node 101 to 104, then to 107, then to 110, then to 111, and then to 109. In some embodiments, the other instances may be performed.

In some instances, the random walk simulation takes steps based on previous transfers between nodes. For example, in each instance of the RWS, the system may randomly select a transfer from the origination node thereby leading the RWS to another node (e.g., a second node). The RWS may then repeat the process by randomly selecting a transfer out of the second node to a third node, and so on. In some instances, randomly selecting may include using a random number generator to select a transfer to follow. For example, if a node has 100 transfers leaving it, the system may generate a random number of 62. Thus, the system may follow the 62^{nd} transaction. In some embodiments, each subsequent transfer for an instance of the RWS occurs after the previous transfer. For example, a money transfer from node 101 to node 104 may not take place after a money transfer from node 104 to node 107 because the simulation may then produce results that could not happen in reality since the money would not have reached node 104.

In some embodiments, node 109 is a common convergence node for the instances of the RWS simulation. In some embodiments, convergence node 109 is a common step for a significant percentage of the instances. For example, the significant percentage may be set by a user for an RWS. In a further example, if money laundering generally sends about 75% of the final money to a single destination, the significant percentage may be set at 75%. In some embodiments, a convergence node may have other transfers going out to other nodes. For example, 90% of the transfers from an origination node have simulations that stop by a convergence node but continue on to other nodes. All simulations do not need to stop at the convergence node to be considered significant. For example, all instances of the simulation may continue on to other nodes.

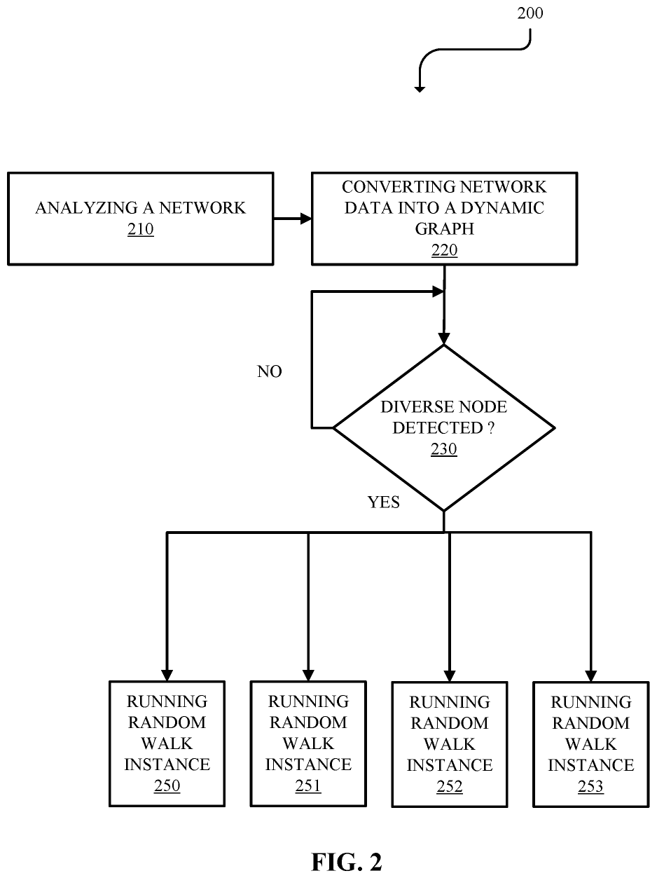

FIG. 2 depicts an example flow graph 200 for performing random walk simulations in parallel. In some embodiments, flow graph 200 begins at step 210 by analyzing a network and the network data to convert the network data into a dynamic graph in step 220. In some embodiments, a system performing the simulation may receive a dynamic network graph. In some instances, a dynamic network graph can be represented as an ordered list or an asynchronous stream of timed events, such as additions or deletions of nodes and edges. The network may be a social media network, a financial network, a data network, a cloud network, or any other network were data, messages, information, currency, crypto currency, non-fungible tokens, or anything of value is transferred.

In some embodiments, an origination node is selected. In some embodiments, step 230 may determine if the node is diverse (e.g., referred to as an origination node herein). If the node is not diverse (“NO” at step 230), the system may move on to another node and repeat step 230. In some embodiments, to determine if a node is diverse, the system may evaluate one or more nodes to evaluate if the node meets a number of factors such as the number of outgoing transfers and the size of the outgoing transfers. For example, candidate diverse nodes may have greater than 1000 transfers that are all less than $1000 indicating a possibility of one or more illicit transfer (e.g., an attempt to send a significant amount of money via transactions that are all smaller than some “flaggable” amount), though in other examples other factors may be set by the system to identify potentially illicit transfers according to profiles of illicit transfers (e.g., what characteristics illicit transfers may exhibit). In some embodiments, an origination node is a starting point for a random walk simulation. In some embodiments, the selecting may be performed by identifying nodes with more than a threshold number of transfers and with a percentage of the transfers are under a transfer limit. The threshold number of transfers is a minimum number of transfers that would warrant a simulation. For example, illicit activity for accounts may involve more than 100 transfers per day, thus the threshold number may be above 100. In some instances, the users of the simulation may determine the threshold for the minimum number of transfers. In some instances, the system may determine the threshold based on the number of candidate nodes that qualify. For example, the system may have allotted resources that would only allow it to run simulations on 1000 nodes, thus the system would choose the 1000 nodes with the most transfers under the transfer limit. In some embodiments, the transfer limit is the highest amount that may be considered for a transfer. For example, transfers over $10,000 may already be monitored by a government agency and are therefore unlikely to be involved in illicit activity. In some embodiments, running the simulations in parallel may include running the simulations at the same time, in batches, in a sequence, or other method as system resources dictate.

In some embodiments, the system may deploy a random walk simulation on the dynamic network graph simulating steps from the origination node to one or more other nodes. In some embodiments, the dynamic network graph may have a multitude of nodes and there may be links or edges between the nodes. In some embodiments, the links or edges are transfers from one node to another. For example, a first node may send a second node an amount of money, cryptocurrency, data, or a message. In some embodiments, the system may identify messages that are under a certain size. For example, the system may filter out any messages that are over 100 MB.

In some embodiments, if the node is detected as diverse (“YES” at step 230), the random walk simulation performs a plethora of parallel instances steps 250, 251, 252, 253 (only four instances are shown many instances may be run in parallel) by randomly selecting a transfer from a current node for each instance, where the current node is the origination node for each instance. In some embodiments, the transfer leads the simulation to a recipient node that received the transfer. In some embodiments, the recipient node is the current node. The system then repeats the randomly selecting and identifying steps up to a set number of times. For example, each node may be a step in an instance of the random walk simulation. The number of steps (length of each random walk) in a simulation may be set at a maximum of simulations (e.g., a threshold number of steps). For example, the threshold number of steps may be set at T=10, thus each instance may have up to 10 steps. Likewise, a number of instances for each simulation may also be set. For example, 1000 instances of the random walk simulation may be held. In some cases, the number of instances may also be a percentage of the total number of transfers (or total number of transfers meeting a criteria) from the origination node.

In some embodiments, the system may determine, from the results of the random walk simulations, a convergence node for the random walk simulation. For example, the convergence node may be a node that at least 50% of the instances of a simulation have as a step. In some embodiments, the system may identify and use candidate transfers that fall within a time period and under a certain transfer limit. For example, the system may investigate transfers that happen within a one-week period.

In some embodiments, the convergence node may be flagged as a suspicious node. The convergence node may be a node that received enough transfers that may have originated at the origination node that a further investigation may be warranted by authorities. For example, authorities may deem it appropriate to investigate transfers where the threshold number of simulations is more than 50% of the simulations. Different types of possible illicit activity may have different thresholds.

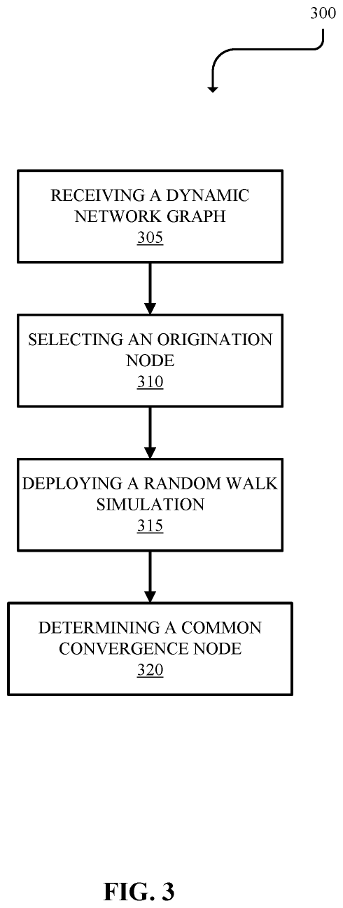

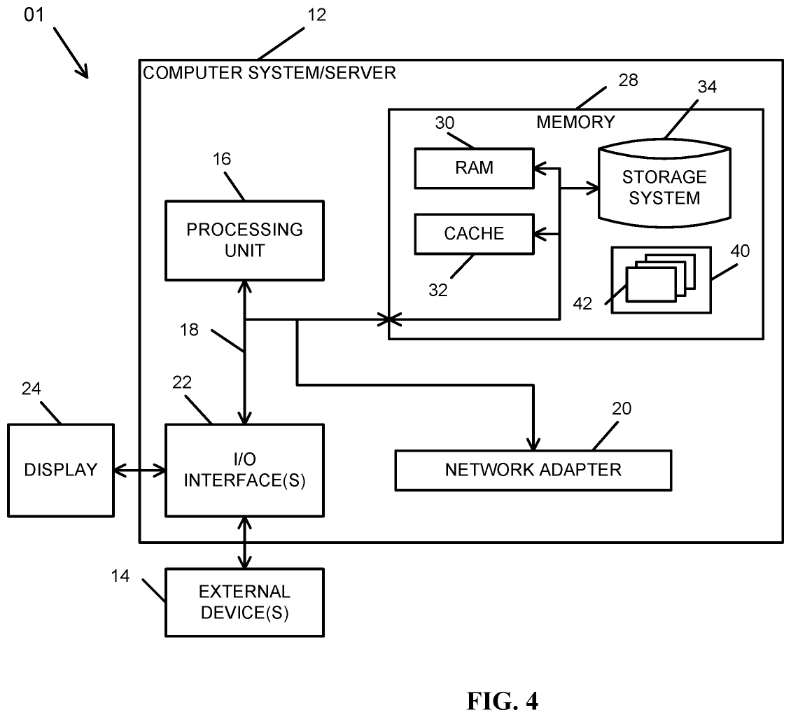

FIG. 3 depicts an example method 300 for detecting network patterns using random walks. Operations of method 300 may be enacted by one or more computer systems such as the system described in FIG. 4 below.

Method 300 begins with operation 305 of receiving a dynamic network graph. In some embodiments, the dynamic network graph may be a network map, a table of data, a table of transfers between nodes, a matrix of network connections with transfer metadata, or other means of conveying how and when a transfer is performed between nodes.

Method 300 continues with operation 310 of selecting an origination node. In some embodiments, the origination node may be selected based on a candidate node having more than a threshold number of transfers where a certain percentage of the transfers are below a transfer limit. In some embodiments, the threshold number may be a percentage of transfers or a certain number of transfers. In some embodiments, the transfer limit may be set by a system operator. For example, the system operator may determine that normal systems flag transfers over $10,000, so the transfer limit may be set to less than $10,000. In some embodiments, the simulation may be performed multiple times with varying transfer limits to optimize the set transfer limit. For example, simulations with transfers under 10,000 may have too many legitimate transfers creating noise making it difficult to find illegitimate transfers.

Method 300 continues with operation 315 of deploying a random walk simulation. In some embodiments, a random walk simulation creates multiple instances evaluating how transfers happen from one node to another. In some embodiments, in operation 320 below, the results of the simulation may be used to find a convergence node for the instances.

In some embodiments, transfers between accounts may be possible steps for the random walk simulation. For example, there may be 4 linked nodes (nodes A, B, C, and D) that have received transfers from a first node. The first node may have made a transferred money to node A 100 times, node B 200 times, node C 300 times, and node D 400 times. Each transfer is a possible step for the random walk. Thus, a step from the first node to node D may be 4 times more likely than a step from the first node to node A (since there were 400 transfers from the first node to node D and 100 transfers to node A). Subsequent steps from nodes A, B, C, and D to other nodes may also be simulated and so on from those other nodes to the next level of nodes. In some embodiments, a maximum number of steps may be set for the steps (e.g., 5 steps between nodes).

Method 300 continues with operation 320 of determining a common convergence node for the random walk simulation. In some embodiments, the random step simulation may be performed a set number of times, and the simulation results may be analyzed.

In an exemplary embodiment, the system includes computer system 01 as shown in FIG. 4 and computer system 01 may perform one or more of the functions/processes described above. Computer system 01 is only one example of a computer system and is not intended to suggest any limitation as to the scope of use or functionality of embodiments of the present invention. Regardless, computer system 01 is capable of being implemented to perform and/or performing any of the functionality/operations of the present invention.

Computer system 01 includes a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 12 may be described in the general context of computer system-executable instructions, such as program modules, being executed by a computer system. Generally, program modules may include routines, programs, objects, components, logic, and/or data structures that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computer system 01 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As is further depicted and described below, memory 28 may include at least one program product having a set (e.g., at least one) of program modules that are configured to carry out the functions/operations of embodiments of the invention.

Program/utility 40, having a set (at least one) of program modules 42, may be stored in memory 28 by way of example, and not limitation. Exemplary program modules 42 may include an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention.

Computer system/server 12 may also communicate with one or more external devices 14 such as a keyboard, a pointing device, a display 24, one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Cloud Computing

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

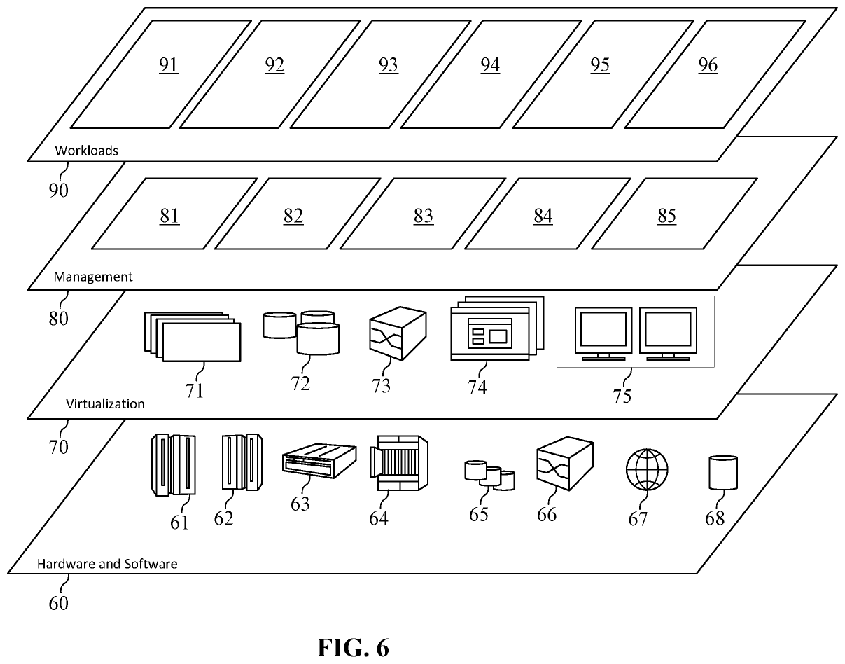

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and predictive neural networks 96.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory; and
a processor in communication with the memory, the processor being configured to perform processes comprising:
receiving a dynamic network graph;
selecting an origination node;
deploying a random walk simulation on the dynamic network graph simulating steps from the origination node to one or more other nodes; and
determining, from the results of the random walk simulations, a convergence node for the random walk simulation.

2. The system of claim 1, wherein the selecting further comprises:
identifying nodes with more than a threshold number of transfers and with a percentage of transfers are under a transfer limit.

3. The system of claim 2, wherein the process further comprises:
identifying candidate transfers that fall within a time period and under a certain transfer limit.

4. The system of claim 1, wherein the deploying further comprises:
randomly selecting a transfer from a current node; and
determining a recipient node receives the transfer.

5. The system of claim 4, wherein the deploying further comprises:
setting the recipient node as the current node; and
repeating the randomly selecting and the identifying up to a set number of times.

6. The system of claim 1, wherein the process further comprises:
determining the convergence node was in a threshold number of simulation instances; and
flagging the convergence node as a suspicious node.

7. The system of claim 6, wherein the threshold number of simulations is more than 50% of the simulations.

8. A method comprising:
receiving a dynamic network graph;
selecting an origination node;
deploying a random walk simulation on the dynamic network graph simulating steps from the origination node to one or more other nodes; and
determining, from the results of the random walk simulations, a convergence node for the random walk simulation.

9. The method of claim 8, wherein the selecting further comprises:
identifying nodes with more than a threshold number of transfers and with a percentage of transfers are under a transfer limit.

10. The method of claim 9, wherein the process further comprises:
identifying candidate transfers that fall within a time period and under a certain transfer limit.

11. The method of claim 8, wherein the deploying further comprises:
randomly selecting a transfer from a current node; and
determining a recipient node receives the transfer.

12. The method of claim 11, wherein the deploying further comprises:
setting the recipient node as the current node; and
repeating the randomly selecting and the identifying up to a set number of times.

13. The method of claim 8, wherein the process further comprises:
determining the convergence node was in a threshold number of simulation instances; and
flagging the convergence node as a suspicious node.

14. The method of claim 13, wherein the threshold number of simulations is more than 50% of the simulations.

15. A computer program product comprising a computer readable storage medium having program instructions embodied therewith, the program instructions executable by a processor to cause the processors to perform a method, the method comprising;
receiving a dynamic network graph;
selecting an origination node;
deploying a random walk simulation on the dynamic network graph simulating steps from the origination node to one or more other nodes; and
determining, from the results of the random walk simulations, a convergence node for the random walk simulation.

16. The computer program product of claim 15, wherein the selecting further comprises:
identifying nodes with more than a threshold number of transfers and with a percentage of transfers are under a transfer limit.

17. The computer program product of claim 16, wherein the method further comprises:
identifying candidate transfers that fall within a time period and under a certain transfer limit.

18. The computer program product of claim 15, wherein the deploying further comprises:
randomly selecting a transfer from a current node; and
determining a recipient node receives the transfer.

19. The method of claim 18, wherein the deploying further comprises:
setting the recipient node as the current node; and
repeating the randomly selecting and the identifying up to a set number of times.

20. The method of claim 15, wherein the process further comprises:
determining the convergence node was in a threshold number of simulation instances; and
flagging the convergence node as a suspicious node.
